(19) United States
(12) Patent Application Publication
(10) Pub. No.: US 2017/0279285 A1
(43) Pub. Date: Sep. 28, 2017

(54) CHARGING DEVICE AND CONTROL METHOD THEREOF

(71) Applicant: ANPEC ELECTRONICS CORPORATION, HSINCHU CITY (TW)

(72) Inventors: CHIH-NING CHEN, TAIPEI CITY (TW); CHIH-HENG SU, HSINCHU CITY (TW)

(21) Appl. No.: 15/198,446

(22) Filed: Jun. 30, 2016

(30) Foreign Application Priority Data
Mar. 25, 2016 (TW) 105109451

(51) Int. Cl. H02J 7/00

(52) U.S. Cl. CPC H02J 7/0044; H02J 7/0052; H02J 7/007; H02J 2007/0059; H02J 2007/0062

(57) ABSTRACT

Disclosed are a charging device and a control method thereof. The charging device comprises an adapter, an energy storage unit and a charging module. The adapter provides an input current. The charging module receives the input current and provides a first charging current to charge the energy storage unit, or an output current to charge an electronic device. When the input current is higher than or equal to a preset current, the charging module works in a boost mode, such that the energy storage unit provides a second charging current to the charging module. The second charging current varies with the load of the electronic device. When the second charging current decreases to 0, the charging module turns to work in a buck mode, such that the energy storage unit is charged according to the input current.

### BACKGROUND OF THE INVENTION

1. Field of the Invention

The instant disclosure relates to a charging device; in particular, to a charging device that can provide an electric energy safely and effectively.

2. Description of Related Art

With the development of technology, portable electric devices have become essential in people's lives, such as the mobile phone, the tablet, the music player, the video player or the like that have an USB interface.

Usually, the portable electric devices consume power quickly, so the users are used to keeping a charging device, such as a power bank, at hand to charge their portable electric devices if necessary. The charging device is usually an OTG (On The Go) device. In other words, the charging device can be a peripheral device to receive power from other devices, such as a personal computer, or can be a host device to charge other slave devices, such as the mobile phone, the tablet or the like. Moreover, a recently developed charging device can provide the electric energy to the mobile phone, the tablet or the like as it is charged.

The above charging device has a buck converter and a boost converter. The buck converter and the boost converter respectively comprise an upper-bridge switch and a lower-bridge switch. When the charging device needs to be charged, the charging device enables a buck converter and makes the voltage of a commercial power convert to a proper level by adjusting the duty cycle of the upper-bridge switch and the lower-bridge switch of the buck converter. On the other hand, when the charging device needs to charge an electronic device, the charging device enables a boost converter and provides an electric energy of which the voltage has been stepping up to a proper level by adjusting the duty cycle of the upper-bridge switch and the lower-bridge switch of the boost converter. Briefly, a traditional charging device works by a buck converter and a boost converter.

The working principle of the traditional charging device is as follows. Receiving commercial power, an adapter of the traditional charging device can provide a current. If the maximum of the current is, for example, 1 A but an electric device to be charged needs a 1.5 A current, and the electric energy provided by the adapter is apparently insufficient for the electric device. As a result, the charging device enables the boost converter, such that the battery in the charging device can also provide electric energy to the electronic device. In other words, the adapter provides a 1 A current and the battery provides a 0.5 A current and thus the electric device can receive a 1.5 A current.

However, the traditional charging device has certain problems. One of them is that, with the decrease of the load of the electric device, the electronic device may only need 1.2 A current. However, in the above example, the current provided by the battery to the electronic device is still 0.5 A and thus the adapter only needs to provide a 0.7 A current to the electronic device. The current provided by the adapter decreases, so the traditional charging device wrongly detects that the electric energy provided by the adapter is sufficient for the electric energy needed by the electric device, and turns to enable the buck converter and starts to charge the battery. Nevertheless, the adapter cannot provide a sufficient electric energy to the electronic device, and eventually the traditional charging device will again turn to enable the boost converter so that the battery can provide part of electric energy that the electric device needs. Briefly, the traditional charging device keeps changing its working mode (for example, from the buck converter to the boost converter, or from the boost converter to the buck converter), and thus is unable to provide electric energy to the electric device stably.

Additionally, another problem that the traditional charging device is that, there is a period of time needed for the traditional charging device to wait for its processor to determine what kind of control signal should be sent to change its working mode (for example, from the buck mode to the boost mode, or from the boost mode to the buck mode). Thus, the traditional charging device may not be able to immediately provide electric energy to an electronic device. In other words, there must be a wait time before the traditional charging device responds to a request for charging from an electric device.

### SUMMARY OF THE INVENTION

The instant disclosure provides a charging device that is used to charge an electronic device. The charging device comprises an adapter, an energy storage unit and a charging module. The adapter is connected to an input interface, receives commercial power via the input interface and provides an input current. The energy storage unit stores and provides energy. The charging module receives the input current, and provides a first charging current to charge the energy storage unit or provides an output current to charge the electronic device. The charging module comprises an upper-bridge switch, a lower-bridge switch, a boost control logic and a buck control logic. The upper-bridge switch is connected to the adapter, the energy storage unit and the electronic device. The lower-bridge switch is connected to the upper-bridge switch and the energy storage unit. The boost control logic is connected to gate of the upper-bridge switch and gate of the lower-bridge switch to control the charging module to operate in a boost mode. The buck control logic is connected to gate of the upper-bridge switch and gate of the lower-bridge switch to control the charging module to operate in a buck mode. The charging module operates in the boost mode when the input current is larger than or equal to a preset current. In the boost mode of the charging module, the boost control logic adjusts a duty cycle of the upper-bridge switch and a duty cycle of the lower-bridge switch, such that the energy storage unit provides a second charging current to the charging module. The second charging current varies with the load of the electronic device. The charging module operates in the buck mode when the second charging current decreases to 0 or below 0. In the buck mode of the charging module, the buck control logic adjusts the duty cycle of the upper-bridge switch and the duty cycle of the lower-bridge switch, such that the energy storage unit is charged according to the input current.

The instant disclosure further provides a control method used in a charging device, wherein the charging device comprises an adapter, a charging module and an energy storage unit. The control method comprises: step A: detecting an input current provided by the adapter; step B: determining whether the input current is equal to or larger than a preset current; step C: providing a first charging current to charge the energy storage unit when the input current is less than the preset current; step D: controlling the charging module to operate in a boost mode when the input current is equal to or larger than the preset current, and adjusting a duty cycle of the upper-bridge switch and a duty cycle of the lower-bridge switch, such that the energy storage unit provides a second charging current to the charging module, wherein the second charging current varies with the load of the electronic device; and step E: controlling the charging module to operate in a buck mode when the second charging current decreases to 0 or below 0, and adjusting the duty cycle of the upper-bridge switch and the duty cycle of the lower-bridge switch, such that the energy storage unit is charged according to the input current.

To sum up, when the load of an electronic device is a heavy load, the charging device and the control method thereof provided by the instant disclosure can maintain an input current provided by an adapter at a safe current level, and helps the adaptor via an energy storage unit provide electric energy to the electronic device. Thereby, the adapter will not be damaged by a high output power thereof Moreover, the charging device and the control method thereof provided by the instant disclosure can dynamically adjust a second charging current provided by the energy storage unit, and can directly detect the second charging current to determine whether to end the boost mode of the charging module. Compared with an energy storage unit of a traditional charging device that can only provide a constant current, the charging device and the control method thereof provided by the instant disclosure will not make the charging device work in a wrong mode due to variation or sudden change of the input voltage provided by the adapter.

For further understanding of the instant disclosure, reference is made to the following detailed description illustrating the embodiments of the instant disclosure. The description is only for illustrating the instant disclosure, not for limiting the scope of the claim.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a schematic diagram of a charging device of one embodiment of the instant disclosure.

FIG. 2 shows a schematic diagram of a charging module of one embodiment of the instant disclosure.

FIG. 3 shows a flow chart of a control method used in a charging device of one embodiment of the instant disclosure.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

It will be understood that, although the terms first, second, third, and the like, may be used herein to describe various elements, but these elements should not be limited by these terms. These terms are only to distinguish one element, component, region, layer, or section from another element, component, region, layer, or section discussed below. Thus, a first element, component, region, layer, or section discussed below could be termed a second element, component, region, layer, or section without departing from the teachings of the instant disclosure. As used herein, the term “and/or” includes any and all combinations of one or more of the associated listed items.

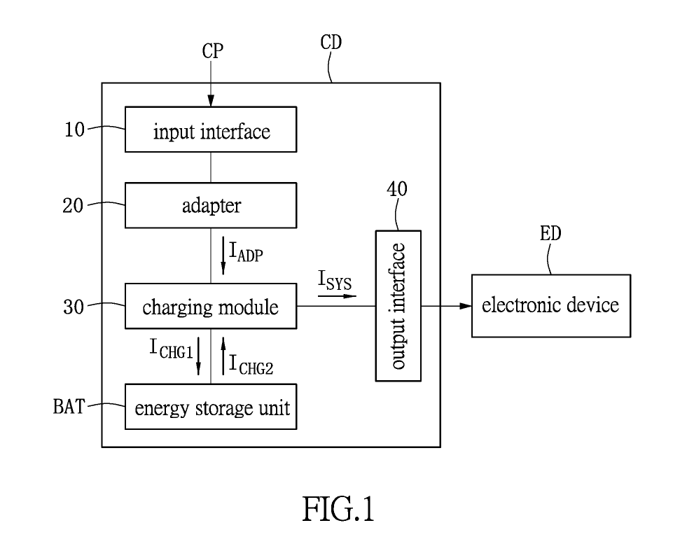

Refer to FIG. 1. FIG. 1 shows a schematic diagram of a charging device of one embodiment of the instant disclosure. The charging device CD can be, for example, a power bank, which is an OTG device. Briefly, the charging device CD can receive and convert commercial power CP into another form of electric energy and store the electric energy. The charging device CD can also provide the stored electric energy to other electric devices. The charging device CD comprises at least one input interface 10, an adapter 20, a charging module 30, an energy storage unit BAT and at least one output interface 40. The adapter 20 is connected to the input interface 10 and the charging module 30. The charging module 30 is connected to the energy storage unit BAT and the output interface 40. In addition, the electronic device ED is connected to the output interface 40.

The electronic device ED can be, for example, a mobile phone, a tablet, a music player or a video player having a USB interface, but it is not limited herein. The electronic device ED receives an output current ISYS provided by the charging module 30 via the output interface 40, and the electronic device ED is charged according to the output current ISYS.

The input interface 10 can be, for example, a universal serial bus (USB) interface, to receive commercial power CP and output the received commercial power CP to the adapter 20. In addition, for ease of understanding, the charging device CD comprises only one input interface 10 in this embodiment, but it is not limited herein. In other embodiments, the charging device CD can comprise more than one input interface 10, which can make the charging device CD charge much more quickly.

The output interface 40 can also be a universal serial bus (USB) interface, to output the electric energy stored in the charging device to the corresponding electronic device ED. For ease of understanding, the charging device CD comprises only one output interface 40 in this embodiment, but it is not limited herein. In other embodiments, the charging device CD can comprise more than one output interface 40 and each output interface 40 is connected to one electronic device ED, which makes the charging device CD able to charge a plurality of electronic devices simultaneously.

The energy storage unit BAT can be, for example, a battery that can store the received power or can convert the stored power into electric energy that can be used by the electronic device ED.

The adapter 20 comprises proper logics, circuits or codes and is configured to step up or step down the voltage of the commercial power according to the Farady's law. In addition, the adapter 20 further comprises a rectifying circuit. The rectifying circuit of adapter 20 converts the commercial power into a direct voltage and provides the direct voltage to the charging module 30.

The charging module 30 receives an input current IADP, and provides a first charging current ICHG1 to charge the energy storage unit BAT or provides an output current ISYS to charge the electronic device ED. The charging module 30 can work in a boost mode or a buck mode according to the present working state of the charging device CD, to charge the energy storage unit BAT or the electronic device ED. When the charging module 30 is working in the buck mode, it provides electric energy to both the energy storage unit BAT and the electronic device ED according to the input current IADP. When the energy storage unit BAT can store no more electric energy, the charging module 30 only charges the electronic device ED. On the other hand, when the charging module 30 is working in the boost mode, the charging module 30 provides electric energy to the electronic device ED, and the energy storage unit BAT provides power to the charging module 30. After that, the charging module 30 outputs an output current ISYS for providing the electric energy that the electronic device needs. It should be noted that, the output current ISYS equals to the sum of the input current IADP and the current provided by the energy storage unit BAT.

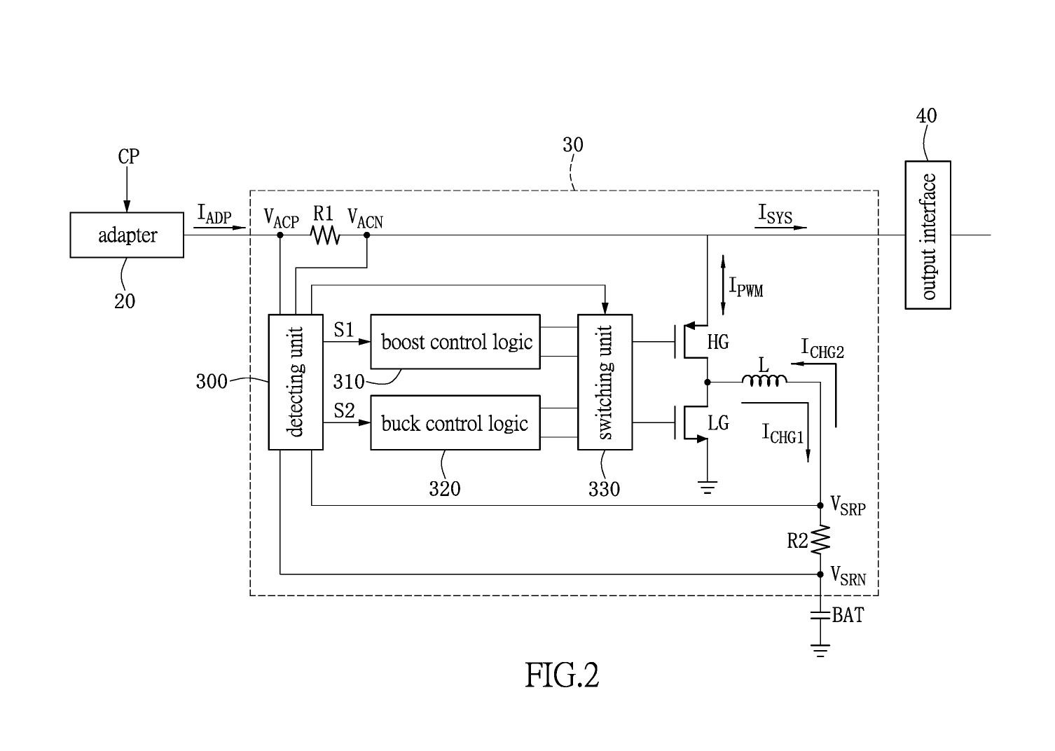

The structure of the charging module 30 is described as follows. Refer to FIG. 2. FIG. 2 shows a schematic diagram of a charging module of one embodiment of the instant disclosure. The charging module 30 comprises a detecting unit 300, a boost control logic 310, a buck control logic 320, a switching unit 330, an upper-bridge switch HG, a lower-bridge switch LG, an inductor L, a first resistor R1 and a second resistor R2. The first resistor R1 is connected to the adapter 20. The second resistor R2 is connected to the energy storage unit BAT. The detecting unit 300 is connected to the boost control logic 310, the buck control logic 320, two ends of the first resistor R1 and two ends of the second resistor R2. The switching unit 330 is connected to the boost control logic 310, the buck control logic 320, the detecting unit 300, the upper-bridge switch HG and the lower-bridge switch LG. The boost control logic 310 is connected to the gate of the upper-bridge switch HG and the gate of the lower-bridge switch LG via the switching unit 330. The buck control logic 320 is connected to the gate of the upper-bridge switch HG and the gate of the lower-bridge switch LG via the switching unit 330. The upper-bridge switch HG is connected to the adapter 20, the output interface 40 and a first end of the inductor L. The lower-bridge switch LG is connected to the upper-bridge switch HG and the first end of the inductor L. A second end of the inductor L is connected to a first end of the second resistor R2. A second end of the second resistor R2 is connected to a first end of the energy storage unit BAT. A second end of the energy storage unit BAT is grounded.

In addition, in this embodiment, the upper-bridge switch HG is a PMOS transistor, and the lower-bridge switch LG is a NMOS transistor, but it is not limited herein. In other embodiments, the upper-bridge switch HG and the lower-bridge switch LG can be a PMOS transistor, a NMOS transistor or the like.

The source of the upper-bridge switch HG is connected to the adapter 20 to receive the input current IADP provided by the adapter 20. The drain of the lower-bridge switch LG is connected to drain of the upper-bridge switch HG and the first end of the inductor L. The source of the lower-bridge switch LG is grounded.

The working mechanism of the upper-bridge switch HG and the lower-bridge switch LG is related to the current passing through the inductor L. Specifically, the first charging current ICHG1 flowing towards the energy storage unit or the second charging current ICHG2 provided by the energy storage unit BAT can be controlled by controlling the duty cycle of the upper-bridge switch HG and the duty cycle of the lower-bridge switch LG. The second charging current ICHG2 flows towards a direction opposite to the flowing direction of the first charging current ICHG1. The second charging current ICHG2 varies with a change of the load of the electronic device ED. When the electronic device ED needs more electric energy, the voltage VACN of one end of the first resistor R1 drops. To maintain the voltage VACN, the adapter 20 increases the input current IADP. If the input current IADP is too much, the second charging current ICHG2 provided by the energy storage unit BAT will be increased, such that the adapter 20 can provide less electric energy to the electronic device ED, and makes the adapter 20 supply input current IADP at a safe current level

On the contrary, when the electronic device ED needs less electric energy, the voltage VACN of one end of the first resistor R1 is raised. After that, the adapter 20 decreases the input current IADP, and the energy storage unit BAT decreases the second charging current ICHG2.

The detecting unit 300 comprises proper logics, circuits or codes and is configured to detect the input current IADP provided by the adapter 20 and to output a first detecting signal Si to the boost control logic 310, wherein the first detecting signal Si indicates the magnitude of the input current IADP. For example, the detecting unit 300 comprises a plurality of comparators. A first comparator (not shown in FIG. 2) of the detecting unit 300 is configured to determine the magnitude relationship between the input current IADP and a preset current. Specifically, the detecting unit 300 detects the voltages VACP and VACN of two ends of the first resistor R1 and determines the magnitude of the input current IADP according to the voltage difference between two ends of the first resistor R1 (that is, the difference between the voltages VACP and VACN). One input end of the first comparator receives the input current IADP, and another input end of the first comparator receives the preset current. The first comparator determines whether the input current IADP is equal to or larger than the preset current. If the input current IADP is equal to or larger than the preset current, the first comparator outputs the first detecting signal S1 at high level to the boost control logic 310 and the switching unit 330.

It should be noted that, the magnitude of the preset current is not restricted herein, and those skilled in the art can adjust the preset current depending on need.

The detecting unit 300 also detects the second charging current ICHG2 provided by the energy storage unit BAT and outputs a second detecting signal S2 to the buck control logic 320, wherein the second detecting signal S2 indicates the magnitude of the second charging current ICHG2. In the above example, a second comparator (not shown in FIG. 2) of the detecting unit 300 determines the magnitude of the second charging current ICHG2. Specifically, the detecting unit 300 detects the voltages VSRP and VSRN of two ends of the second resistor R2, and determines the magnitude of the second charging current ICHG2 according to the voltage difference between two ends of the second resistor R2 (that is, the difference between the voltages VSRP and VSRN). One input end of the second comparator receives the second charging current ICHG2, and the second comparator determines whether the second charging current ICHG2 is equal to or less than 0. If the second charging current ICHG2 is equal to or less than 0, the second comparator outputs the second detecting signal S2 at high level to the buck control logic 320 and the switching unit 330.

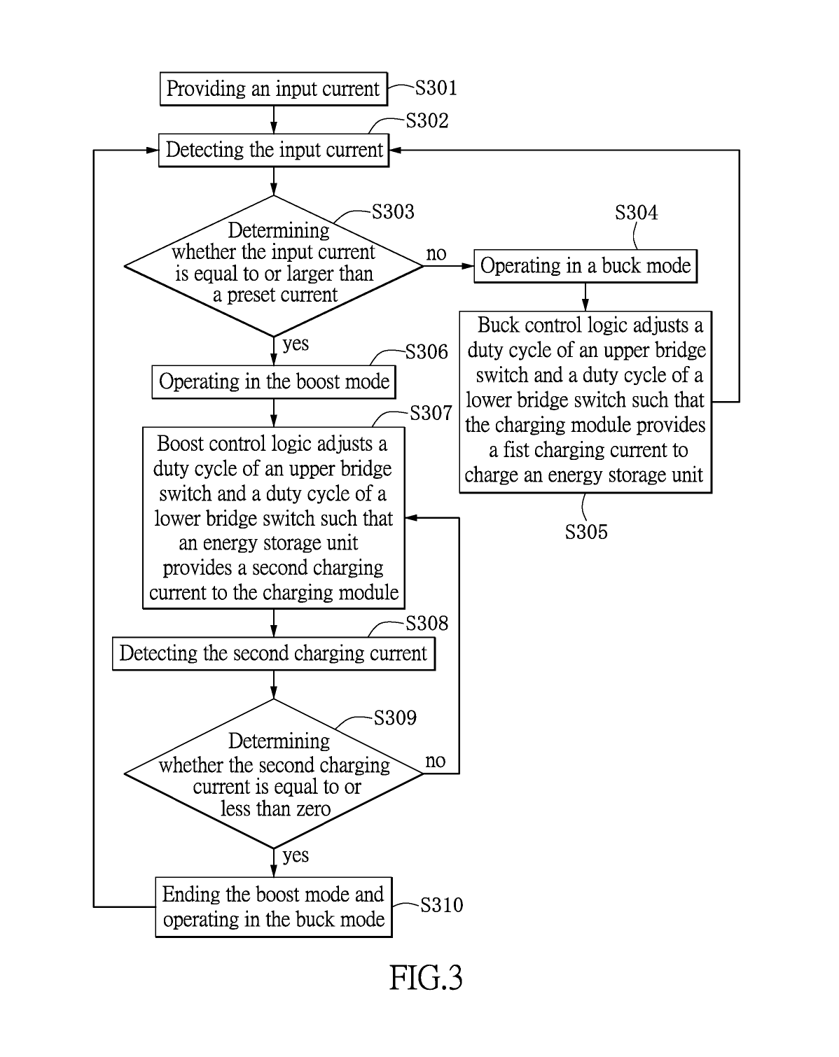

The boost control logic 310 comprises proper logics, circuits or codes and is configured to control the charging module 30 to work in the boost mode. When the boost control logic 310 receives the first detecting signal S1 at high level provided by the detecting unit 300, the boost control logic 310 outputs a first pulse width modulation signal to the upper-bridge switch HG and a second pulse width modulation signal to the lower-bridge switch LG, to adjust the duty cycle of the upper-bridge switch HG and the duty cycle of the lower-bridge switch LG. The details about how the boost control logic 310 adjusts the duty cycle of the upper-bridge switch HG and the duty cycle of the lower-bridge switch LG are illustrated in the following. Please refer to FIG. 3.

The buck control logic 320 comprises proper logics, circuits or codes and is configured to control the charging module 30 to work in the buck mode. When the buck control logic 320 receives the second detecting signal S2 at high level provided by the detecting unit 300, the buck control logic 320 outputs a third pulse width modulation signal to the upper-bridge switch HG and outputs a fourth pulse width modulation signal to the lower-bridge switch LG, to adjust the duty cycle of the upper-bridge switch HG and the duty cycle of the lower-bridge switch LG. The details about how the buck control logic 320 adjusts the duty cycle of the upper-bridge switch HG and the duty cycle of the lower-bridge switch LG are illustrated in the following. Please refer to FIG. 3.

The switching unit 330 comprises proper logics, circuits or codes and is configured to selectively control the boost control logic 310 to be connected to the upper-bridge switch HG and the lower-bridge switch LG, or control the buck control logic 320 to be connected to the upper-bridge switch HG and the lower-bridge switch LG. Specifically, when the switching unit 330 receives the first detecting signal S1 at high level, the switching unit 330 is connected to the boost control logic 310, the gate of the upper-bridge switch HG and the gate of the lower-bridge switch LG, such that the upper-bridge switch HG is turned on or off according to the first pulse width modulation signal and the lower-bridge switch LG is turned on or off according to the second pulse width modulation signal, to adjust the first charging current ICHG1.

On the other hand, when the switching unit 330 receives the second detecting signal S2 at high level, the switching unit 330 is connected to the buck control logic 320, the gate of the upper-bridge switch HG and the gate of the lower-bridge switch LG, such that the upper-bridge switch HG is turned on or off according to the third pulse width modulation signal and the lower-bridge switch LG is turned on or off according to the fourth pulse width modulation signal, to adjust the second charging current ICHG2.

Briefly, the switching unit 330 can control the boost control logic 310 and the buck control logic 320 according to the working state of the charging module 30, such that the magnitude and flowing direction of the current passing through the inductor L changes, which further changes the magnitude and flowing direction of the current IPWM of the charging module shown in FIG. 2.

When the charging module 30 works in the buck mode, the current passing through the inductor L is the first charging current ICHG1 flowing from the upper-bridge switch HG and the lower-bridge switch LG to the energy storage unit BAT. When the charging module 30 works in the boost mode, the current passing through the inductor L is the second charging current ICHG2 flowing from the energy storage unit BAT to the upper-bridge switch HG and the lower-bridge switch LG. In this embodiment, the current flowing from the upper-bridge switch HG and the lower-bridge switch LG to the energy storage unit BAT is defined as a positive current, and the current flowing from the energy storage unit BAT to the upper-bridge switch HG and the lower-bridge switch LG is defined as a negative current.

The boost control logic 310 records a first current lower bound of the lower-bridge switch LG and the buck control logic 320 records a second current lower bound of the lower-bridge switch LG. The first current lower bound and the second current lower bound indicate whether the negative IL current is allowed or not in the charging module 30. In this embodiment, the first current lower bound is less than 0, and the second current lower bound equals to 0. The boost control logic 310 adjusts the duty cycle of the first pulse width modulation signal and the duty cycle of the second pulse width modulation signal according to the first current lower bound, and further controls the magnitude and the flowing direction of the current IL passing through the inductor L. Likewise, the buck control logic 320 adjusts the duty cycle of the third pulse width modulation signal and the duty cycle of the fourth pulse width modulation signal according to the second current lower bound, and further controls the magnitude and the flowing direction of the current IL passing through the inductor L. The details about how the boost control logic 310 and the buck control logic 320 adjust the current IL passing through the inductor L according to the first current lower bound and the second current lower bound are illustrated in the following description. Please refer to FIG. 3.

The operation of the charging device CD is illustrated in the following description. FIG. 3 shows a flow chart of a control method used in a charging device of one embodiment of the instant disclosure. The control method shown in FIG. 3 can be used in the charging device CD shown in FIG. 1. In this embodiment, the electronic device ED is connected to the charging device CD via the output interface 40. In step S301, the charging device CD is connected to a device that can provide commercial power CP, such as a socket. Receiving the commercial power CP, the adapter 20 starts to provide an input current IADP to the charging module 30 to charge the electronic device ED or the energy storage unit BAT. If the energy storage unit BAT has been fully charged, the charging module 30 turns off the upper-bridge switch HG and the lower-bridge switch LG to stop charging the energy storage unit BAT. As a result, the input current IADP provided by the adapter 20 is all inputted to the electronic device ED via the output interface 40.

In Step S302, the detecting unit 300 detects the input current IADP. The magnitude of the input current IADP varies with the load of the electronic device ED. When the electronic device ED needs more electric energy, the adapter 20 provides a higher input current IADP.

In step S303, the detecting unit 300 determines whether the input current IADP is equal to or larger than a preset current. The adapter 20 can provide enough of the electric energy that the electronic device ED needs without the energy storage unit as long as the load current needed by the electronic device ED is not over the preset current of the adapter 20, for example, the preset current can be 1 A. In other words, the preset current refers to the maximum input current IADP that the adapter 20 can provide without being damaged. If the input current IADP is not larger than or not equal to the preset current, and it goes to step S304. If the input current IADP is larger than or equal to the preset current, and it goes to step S306.

In step S304, the detecting unit 300 outputs a second detecting signal S2 at high level to the buck control logic 320 and the switching unit 330, such that the charging module 30 works in the buck mode. After that, switching unit 330 controls the buck control logic 320 to be connected to the gate of the upper-bridge switch HG and the gate of the lower-bridge switch LG.

In step S305, the buck control logic 320 outputs a third pulse width modulation signal and a fourth pulse width modulation signal to adjust the duty cycle of the upper-bridge switch HG and the duty cycle of the lower-bridge switch LG. After that, the charging module 30 provides a first charging current ICHG1 to the energy storage unit BAT to charge the energy storage unit BAT. At the same time, the charging module 30 provides an output current ISYS to the output interface 40 to charge the electronic device ED. Briefly, the adapter 20 provides electric energy to the electronic device ED and the energy storage unit BAT simultaneously, wherein the input current IADP equals to the sum of the output current ISYS and the first charging current ICHG1 in the charging device CD. After that, it goes to step S302 to continually detect the input current IADP.

The second current lower bound of the buck control logic 320 equals to 0. In other words, the negative current is not allowed in the buck control logic 320, and thus the current flowing from the drain of the lower-bridge switch LG to the source of the lower-bridge switch LG is zero.

In step S306, the detecting unit 300 detects that the input current IADP provided by the adapter 20 is over the preset current, and thus the load current that the electronic device ED needs cannot be entirely provided by the adapter 20 without damaging the adapter 20. In order to protect the adapter 20 from damaging by a high electric energy, the charging module 30 controls the energy storage unit BAT to provide part of the electric energy that the electronic device ED needs. The detecting unit 300 outputs the first detecting signal S1 at high level to the boost control logic 310 and the switching unit 330, such that the charging module 30 works in the boost mode. After that, the switching unit 330 controls the boost control logic 310 to be connected to the gate of the upper-bridge switch HG and the gate of the lower-bridge switch LG.

In step S307, the boost control logic 310 outputs the first pulse width modulation signal and the second pulse width modulation signal to adjust the duty cycle of the upper-bridge switch HG and the duty cycle of the lower-bridge switch LG.

The first current lower bound of the boost control logic 310 is less than zero, such as −4 A˜−5 A. In other words, the current flowing from the drain of the lower-bridge switch LG to the source of the lower-bridge switch LG is allowed to be negative by the boost control logic 310. Thus, the current IL passing through the inductor L can flow inversely. The energy storage unit BAT starts to provide the second charging current ICHG2 to the charging module 30, such that the second charging current ICHG2 is gradually raised. The current IL passing through the inductor L turns to be negative, and the second charging current ICHG2 flows to the electronic device ED via the upper-bridge switch HG, and as a result the charging module 30 works in the boost mode. For example, the second charging current ICHG2 can be 2 A. The current flowing within the charging device CD have a relationship such that IADP+ICHG2=ISYS.

On the other hand, because the energy storage unit BAT starts to provide part of the electric energy that the electronic device ED needs, the adapter 20 can adjust the input current IADP to be almost equal to the preset current, to protect the adapter 20 from damaging by high electric energy. When the charging module 30 works in the boost mode, the boost control logic 310 repeatedly outputs the first pulse width modulation signal and the second pulse width modulation signal, such that the energy storage unit BAT can dynamically adjust the second charging current ICHG2 to provide enough of the electric energy that the electronic device ED needs.

In step S308, the detecting unit 300 detects the second charging current ICHG2. From the above description, the second charging current ICHG2 varies with a change of the load of the electronic device ED. The detecting unit 300 determines whether the boost mode of the charging module 30 ends according to the second charging current ICHG2.

In step S309, the detecting unit 300 determines whether the second charging current ICHG2 has decreased to 0 or below 0. If the second charging current ICHG2 is not less than 0 or not equal to 0, and it goes to step S307. The energy storage unit BAT continually provides the second charging current ICHG2 to the charging module 30. If the second charging current ICHG2 is less than 0 or equal to 0, and it goes to step S310.

In step S310, the load current that the electronic device ED needs has decreased (for example, the load current that the electronic device ED needs has decreased to 0.8 A), such that the second charging current ICHG2 decreases to be less than or equal to 0. As a result, the adapter 20 can sufficiently provide all electric energy that the electronic device ED needs. Thus, the detecting unit 300 outputs the first detecting signal S1 at low level to the boost control logic 310 and the switching unit 330, and outputs the second detecting signal S2 at high level to the buck control logic 320 and the switching unit 330, such that the charging module 30 ends the boost mode and works in the buck mode again. The buck control logic 320 outputs the third pulse width modulation signal and the fourth pulse width modulation signal to control the duty cycle of the upper-bridge switch HG and the duty cycle of the lower-bridge switch LG. As a result, the energy storage unit BAT decreases the second charging current ICHG2 provided to the charging module 30, and it goes to step S302. In step S302, the detecting unit 300 continues to detect the input current IADP to dynamically determine the working mode of the charging module 30 according to a change of the load of the electronic device ED.

In addition, when the adapter 20 charges the electronic device ED, it can simultaneously charge the energy storage unit BAT to compensate the power consumption of the energy storage unit BAT when the charging module 30 works in the boost mode.

If the input current provided by the adapter 20 is again raised to be larger than or equal to the preset current, the charging module 30 will work in the boost mode again, and steps S306-S310 are repeatedly executed such that the energy storage unit BAT can provide part of the electric energy that the electronic device ED needs.

To sum up, when the load of an electronic device is a heavy load, the charging device and the control method thereof provided by the instant disclosure can maintain an input current provided by an adapter at a safe current level, and help the adaptor via an energy storage unit provide power to the electronic device as required by the electronic device. Thereby, the adapter will not be damaged by a high output power thereof. Moreover, the charging device and the control method thereof provided by the instant disclosure can dynamically adjust a second charging current provided by the energy storage unit, and can directly detect the second charging current to determine whether to end the boost mode of the charging module. Compared with an energy storage unit of a traditional charging device that can only provide a constant current, the charging device and the control method thereof provided by the instant disclosure will not make the charging device work in a wrong mode due to variation or sudden change of the input voltage provided by the adapter.

Additionally, the traditional charging device needs to wait for its processor to determine the working mode, such as the boost mode or the buck mode, according to the present working state, but the charging device and the control method thereof provided by the instant disclosure does not, so that they can provide an electric energy to an electric device more quickly. Also, the charging device and the control method thereof provided by the instant disclosure can determine to work in the boost mode by only detecting the input current provided by the adapter, and can determine to end the boost mode and work in the buck mode just according to the second charging current provided by the energy storage unit. Therefore, compared with the traditional charging device, the charging device and the control method thereof provided by the instant disclosure can respond to a request for charging from an electric device more promptly.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. A charging device, used to charge an electronic device, comprising:
an adapter, connected to an input interface, receiving commercial power via the input interface and providing an input current;
an energy storage unit, storing and providing energy; and
a charging module, receiving the input current and providing a first charging current to charge the energy storage unit, or providing an output current to charge the electronic device, wherein the charging module comprises:
an upper-bridge switch, connected to the adapter, the energy storage unit and the electronic device;
a lower-bridge switch, connected to the upper-bridge switch and the energy storage unit;
a boost control logic, connected to gate of the upper-bridge switch and gate of the lower-bridge switch to control the charging module to operate in a boost mode; and
a buck control logic, connected to the gate of the upper-bridge switch and the gate of the lower-bridge switch to control the charging module to operate in a buck mode;
wherein the charging module operates in the boost mode when the input current is larger than or equal to a preset current, the boost control logic adjusts a duty cycle of the upper-bridge switch and a duty cycle of the lower-bridge switch, such that the energy storage unit provides a second charging current to the charging module, wherein the second charging current varies with the load of the electronic device, the charging module operates in the buck mode when the second charging current decreases to 0 or below 0, the buck control logic adjusts the duty cycle of the upper-bridge switch and the duty cycle of the lower-bridge switch, such that the energy storage unit is charged according to the input current.

2. The charging device according to claim 1, wherein the adapter adjusts the input current to be equal to the preset current to protect the adapter from damaging by a high output power thereof when the adapter operates in the boost mode.

3. The charging device according to claim 1, wherein the charging module further comprises:
a detecting unit, connected to the boost control logic, the buck control logic, the adapter and the energy storage unit, detecting the input current provided by the adapter or the second charging current provided by the energy storage unit;
wherein the detecting unit outputs a first detecting signal to the boost control logic when the input current is equal to or larger than the preset current, and the boost control logic controls the charging module to operate in the boost mode;
wherein the detecting unit outputs a second detecting signal to the buck control logic when the second charging current decreases to 0 or below 0, and the buck control logic controls the charging module to operate in the buck mode.

4. The charging device according to claim 3, wherein the charging module further comprises:
a first resistor, connected to the adapter and the detecting unit, wherein the detecting unit detects the voltage difference between two ends of the first resistor, and determines whether the input current is equal to or larger than the preset current according to the voltage difference between two ends of the first resistor.

5. The charging device according to claim 3, wherein the charging module further comprises:
a second resistor, connected to the energy storage unit and the detecting unit, wherein the detecting unit detects the voltage difference between two ends of the second resistor, and determines whether the second charging current is equal to or less than zero according to the voltage difference between two ends of the second resistor.

6. The charging device according to claim 3, wherein the charging module further comprises:
a switching unit, connected to the boost control logic, the buck control logic, the detecting unit, the upper-bridge switch and the lower-bridge switch, to selectively control the boost control logic or the buck control logic to be connected with the upper-bridge switch and the lower-bridge switch;
wherein the switching unit is connected to the boost control logic, the upper-bridge switch and the lower-bridge switch when the charging module operates in the boost mode, and the upper-bridge switch receives a first pulse width modulation signal and the lower-bridge switch receives a second pulse width modulation signal, to adjust the duty cycle of the upper-bridge switch and the duty cycle of the lower-bridge switch;
wherein the switching unit is connected to the buck control logic, the upper-bridge switch and the lower-bridge switch when the charging module operates in the buck mode, and the upper-bridge switch receives a third pulse width modulation signal and the lower-bridge switch receives a fourth pulse width modulation signal, to adjust the duty cycle of the upper-bridge switch and the duty cycle of the lower-bridge switch.

7. The charging device according to claim 1, wherein the upper-bridge switch is a PMOS transistor and the lower-bridge switch is a NMOS transistor.

8. A control method used in a charging device, the charging device comprising an adapter, a charging module and an energy storage unit, the control method comprising:
step A: detecting an input current provided by the adapter;
step B: determining whether the input current is equal to or larger than a preset current;
step C: providing a first charging current to charge the energy storage unit when the input current is less than the preset current;
step D: controlling the charging module to operate in a boost mode when the input current is equal to or larger than the preset current, and adjusting a duty cycle of the upper-bridge switch and a duty cycle of the lower-bridge switch, such that the energy storage unit provides a second charging current to the charging module, wherein the second charging current varies with the load of the electronic device; and
step E: controlling the charging module to operate in a buck mode when the second charging current decreases to zero or below zero, and adjusting the duty cycle of the upper-bridge switch and the duty cycle of the lower-bridge switch, such that the energy storage unit is charged according to the input current.

9. The control method according to claim 8, wherein in the step D, the adapter adjusts the input current to be equal to the preset current to protect the adapter from damaging by a high output energy thereof.

10. The control method according to claim 8, wherein in the step D, a detecting unit of the charging module detects the input current and outputs a first detecting signal to a boost control logic of the charging module, and the boost control logic controls the charging module to operate in the boost mode.

11. The control method according to claim 10, wherein the detecting unit detects the voltage difference between two ends of a first resistor connected to the adapter, and determines whether the input current is equal to or larger than the preset current according to the voltage difference between two ends of the first resistor.

12. The control method according to claim 10, wherein a switching unit of the charging module is connected to the boost control logic, an upper-bridge switch and a lower-bridge switch when the charging module operates in the boost mode, and the boost control logic respectively outputs a first pulse width modulation signal to the upper-bridge switch and a second pulse width modulation signal to the lower-bridge switch, to adjust the duty cycle of the upper-bridge switch and the duty cycle of the lower-bridge switch.

13. The control method according to claim 8, wherein in the step E, a detecting unit of the charging module detects the second charging current and outputs a second detecting signal to a buck control logic of the charging module, and the buck control logic controls the charging module to operate in the buck mode.

14. The control method according to claim 13, wherein the detecting unit detects the voltage difference between two ends of a second resistor connected to the energy storage unit, and determines whether the second charging current is equal to or less than zero according to the voltage difference between two ends of the second resistor.

15. The control method according to claim 13, wherein a switching unit of the charging module is connected to the buck control logic, an upper-bridge switch and a lower-bridge switch when the charging module operates in the buck mode, such that the buck control logic respectively outputs a third pulse width modulation signal to the upper-bridge switch and a fourth pulse width modulation signal to the lower-bridge switch, to adjust the duty cycle of the upper-bridge switch and the duty cycle of the lower-bridge switch.
